(19) United States
(12) Patent Application Publication
(10) Pub. No.: US 2013/0333339 A1
(43) Pub. Date: Dec. 19, 2013

(54) Equine Eyewear

(71) Applicant: Dustin Wade Brown, Peterson, MN (US)

(72) Inventor: Dustin Wade Brown, Peterson, MN (US)

(73) Assignee: Dustin Wade Brown, Peterson, MN (US)

(21) Appl. No.: 13/987,787

(22) Filed: Apr. 25, 2011

(51) Int. Cl. B68B 7/00

(52) U.S. Cl. CPC B68B 7/00
USPC 54/80.2

(57) ABSTRACT

Equine protective eyewear, including UV rays protection lens, is dimensionally optimized for equine or animals baring similar facial structure. The lens provided in the eyewear range from clear to a variety of colors also having UV rays protection.

I, Dustin Wade Brown have invented a new design for Equine Eyewear, as set forth in the following specification. The claimed Equine Eyewear is meant to protect the eyes of the animal.

FIG. 1 is a front view of the equine eyewear;

FIG. 1 is a side view thereof, with the opposite side being a mirror image;

FIG. 2 is a back view thereof, showing the staggered raised spacers to allow airflow through the eyewear to minimize lens fogging;

I claim: the ornamental design for the Equine Eyewear as shown and described.

### FIELD OF THE INVENTION

The present invention generally relates to protective articles for animals. The invention relates more specifically to equine animal eyewear.

### BACKGROUND OF THE INVENTION

Eyes of animals are similar to humans in the fact that there is a need to protect them.

Eyes get poked out from large weeds while foraging. When animals enter the woods they are at a high risk of getting their eyes poked from tree branches. Lacerations of the eyes occur when other animals swish their tails into the face and eyes of other animals standing next to them. When the eye gets damaged in this way, they are at a high risk of getting infection and the loss of the eye become possible.

When bug pesticide sprays are sprayed on the animal, the eye's need to be shielded from the harmful pesticide sprays entering the eyes.

Animal's eye also can become damaged from the sun's harmful UV rays; there is UV protection in the equine eyewear.

Thus, there is a need to protect the eyes of equine and other animals from debris and UV light.

### BRIEF SUMMARY OF INVENTION

The purpose of the invention is to protect the eyes of equine and other animals. The eyes of animals need to be protected just like humans eye's, they get lacerated, infected, and damage from the sun's harmful UV rays can also occur. The equine eye protection will do just that; protect the eyes from debris and harmful UV light.

### BRIEF SUMMARY OF THE VIEWS OF DRAWING

FIG. 1 is a front view of the Equine Eyewear, illustrating a wearing position on a horse;

FIG. 1 is a side view of the Equine Eyewear, with the opposite side being a mirror image;

FIG. 2 is back view of FIG. 1, illustrating the staggered spacers.

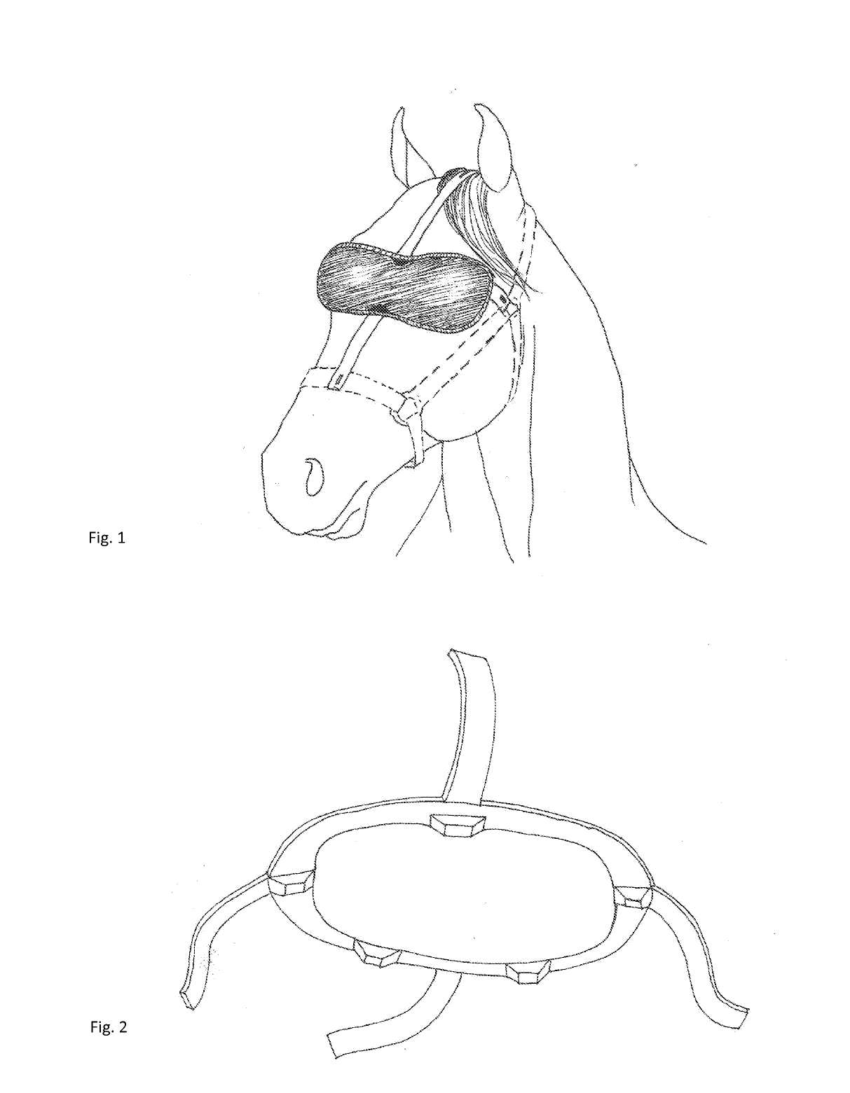

### DETAILED DESCRIPTION OF THE INVENTION

The equine eyewear is made up of a lens that is made from a polycarbonate flexible lens. The lens is scratch resistant and has UV protection. Colored lenses are also available. The lens is embedded into a soft frame to ensure the flexibility of the unit. To minimize fogging of the lens, I have allowed for natural air ventilation between the eyewear and the equine facial structure with a staggered build-up of spacers embedded into the soft frame. Between the spacers there will be an open space where the eyewear does not touch the facial structure so that air will flow freely through the eyewear to minimize fogging of the lens.

There are four straps to be able to secure the eyewear to an existing halter on the face of the animal. The straps located center top, center bottom, and the opposing sides will be permanently sewed to the eyewear. The loose ends will attach to an existing halter already fastened around the facial structure of the animal. The loose ends will have attachments on them to be able to adjust for different size facial structure and tighten to ensure a snug fit.

I claim:

1. Equine eyewear, comprising: a design consisting of a leather frame surrounding a UV protected polycarbonate lens; a raised leather spacer's that are evenly spaced around the face side of the eyewear meant to allow for natural airflow to minimize lens fogging; four leather straps; with one of each of the ends embedded in the eyewear with the opposite loose end to be attached to an existing halter.

2. Equine eyewear as recited in claim 1, different color lens will be available.

3. Equine eyewear as recited in claim 1, ultra violet (UV) and non UV protection coatings will be available.

4. Equine eyewear as recited in claim 1, polycarbonate, plastic and glass eyewear lens will be available.

5. Equine eyewear as recited in claim 1, the raised leather spacers that are evenly spaced around the face side will be a build-up of sewn leather spacers.

6. Equine eyewear as recited in claim 1, four leather straps located middle top, middle bottom, two opposing sides will have one end embedded into eyewear while the opposite will have free ends with attachment devices adhered to it.

7. Equine eyewear as recited in claim 1, the four leather straps will have attachment devices located on the loose, opposite end of the eyewear, attachment devises consisting of buckles, velcro, snaps, leather ties.

8. Equine eyewear as recited in claim 1, the leather frame will be sewed together with a variety of sewing material range from raw hide sinew to high strength fiber.
